(19) United States
(12) Patent Application Publication
(10) Pub. No.: US 2023/0230300 A1
(43) Pub. Date: Jul. 20, 2023

(54) DISPLAY CONTROL DEVICE, DISPLAY CONTROL METHOD AND DISPLAY CONTROL PROGRAM

(71) Applicant: Nippon Telegraph and Telephone Corporation, Tokyo (JP)

(72) Inventors: Sayaka YAGI, Musashino-shi, Tokyo (JP); Kimio TSUCHIKAWA, Musashino-shi, Tokyo (JP); Takeshi MASUDA, Musashino-shi, Tokyo (JP); Fumihiro YOKOSE, Musashino-shi, Tokyo (JP); Yuki URABE, Musashino-shi, Tokyo (JP); Haruo OISHI, Musashino-shi, Tokyo (JP)

(21) Appl. No.: 18/010,577

(22) PCT Filed: Jun. 15, 2020
(86) PCT No.: PCT/JP2020/023484

§ 371 Date: Dec. 15, 2022

(51) Int. Cl. G06T 11/20; G06F 11/32; G06F 11/30

(52) U.S. Cl. CPC G06T 11/206; G06F 11/323; G06F 11/3013

(57) ABSTRACT

A display control apparatus includes a log processing unit that reads an operation log related to operation information and generates first and second object groups indicating operation information represented by first and second visualized representations in first and second two-dimensional planes of a three-dimensional, respectively, the second two-dimensional plane being that is different from the first two-dimensional plane, such that a position of a first object of the first object group and a position of a second object of the second object group which indicate same operation information match on a common axis of the first and second two-dimensional planes, a display control unit that sets a coordinate of each of the first and second objects on the common axis, and a visualization unit that draws an object corresponding to an instructed visualized representation in accordance with the coordinates to perform screen display.

### TECHNICAL FIELD

The present disclosure relates to a display control apparatus, a display control method, and a display control program.

### BACKGROUND ART

Analysts need to accurately grasp work conditions to effectively improve work performance. A method that eliminates personal attribution and makes it possible to efficiently grasp work conditions in a wide range and in detailed level of granularity by acquiring and visualizing operation logs of a terminal has been proposed in the prior art.

As examples of visualized representations of an operation log, visualization in a timeline format (hereinafter, referred to as a “timeline display”) and visualization in a graphical format with nodes and links (hereafter, referred to as a “node-link display”) are known (see NPL 1).

The timeline display is a visualization method in which time is assigned to the x axis (or the y axis), elements are arranged on the y axis (or the x axis), and a temporal length of each element is represented in a rectangular shape, and thus it is suitable for intuitively grasping the context and co-occurrence relationship of the elements. In NPL 1, a timeline display of a window use status on a terminal is implemented based on logs of transitions between active and inactive states of the window.

A node-link display is, for example, a visualization method in which, for example, work or an operation is regarded as one node and a transition between nodes is represented as a link, and thus it is suitable for grasping the order of transitions of work or operations. In NPL 1, with respect to operation logs including information with multiple levels of granularity, such as an application, a window, or operation contents, operations and the like are regarded as nodes, and the same type of operations are aggregated and displayed to achieve a node-link display.

In order for an analyst to discover a work problem, it is effective to combine multiple visualized representations and analyze them according to an analysis perspective. For example, a case in which an analysis purpose is to discover an application target of a Robotic Process Authentication (RPA) tool or the like will be described. In this case, an analyst views the flow of operations in a node-link display to perform analysis in the flow of examining the applicability of a tool by checking the frequency and time of appearance of a corresponding operation in a timeline display while checking the flow of standard operations and the presence or absence of branches in certain work.

In a method in which multiple visualized representations are arranged on a screen like a dashboard that is often found in a common business intelligence (BI) tool, the same data is represented as different visual elements on the multiple visualized representations. For example, in the analysis tool stated in NPL 1, the same data (for example, a specific application) is represented as separate visual elements such as row objects and nodes in a timeline display and a node-link display. Thus, if the analyst does not have a mental map about the meanings of each visualized representation and data structure, the analyst has difficulty in associating elements with one another and efficient analysis. Further, a mental map is a map constructed by a user in his or her head after seeing a visualized result.

Thus, a method (2.5-dimensional display) can be applied, in which the method switches multiple visualized representations seamlessly by disposing a visualization object in a three-dimensional space and observe a first visualized representation when it is viewed from a certain plane (for example, the x-y plane) and a second visualized representation when it is viewed from another plane (for example, the y-z plane). NPL 2 states a 2.5-dimensional display in which a node-link display is combined with a visualized representation expressing time-series changes using a plot of circles.

### CITATION LIST

### Non Patent Literature

NPL 1: Fumihiro Yokose, Yuki Urabe, Sayaka Yagi, Kimio Tsuchikawa, Takeshi Masuda, and Haruo Oishi, “Operation-Visualization Technology to Support Digital Transformation”, NTT Technical Journal, vol. 32, no. 2, pp. 72-75, 2020.
NPL 2: M. Itoh, N. Yoshinaga, M. Toyoda, and M. Kitsuregawa, “3D Visualization of Temporal Changes in Bloggers’ Activities and Interests,” 2011 IEEE Conference on Visual Analytics Science and Technology (VAST), Providence, RI, pp. 283-284, 2011.

### SUMMARY OF THE INVENTION

### Technical Problem

Here, in existing timeline displays and node-link displays, information of applications, windows, operations and the like can be hierarchized and analyzed while switching multiple hierarchical levels.

In the method of NPL 1, it is allowed in timeline displays that dates, users, groups, and the like are treated as hierarchical levels, and the hierarchical levels are set in an arbitrary order. A group is a unit consisting of elements arbitrarily selected by a user and is available to collectively display work and the like. In the node-link displays, logs of multiple users and multiple dates are superimposed and displayed using an order or the like as a key, and hierarchical levels are treated as being fixed in order of applications, windows, and operations. In this way, hierarchy settings have different degrees of freedom depending on visualized representations.

However, switching between complex visualized representations with hierarchical structures is not included in a 2.5-dimensional display. Thus, in a case in which a 2.5-dimensional display is applied to each of visualized representations, and the visualized representations have different hierarchy settings, a user has a difficulty in associating the elements if the user does not have a mental map for the meaning of the visualized representations and data structures as his/her knowledge and skill in advance when switching displays of the visualized representations, and this makes efficient analysis difficult.

The present disclosure has been made in view of the above-described circumstances, and an object of the present disclosure is to provide a display control apparatus, a display control method, and a display control program that enable a user to easily associate elements even in a complex visualized representation for data with a hierarchical structure when displays of two visualized representations are switched.

### Means for Solving the Problem

To solve the above-described problems and achieve the objective, a display control apparatus according to the present disclosure includes a generation unit that reads an operation log related to operation information and generates a first object group indicating operation information represented by a first visualized representation in a first two-dimensional plane of a three-dimensional space and a second object group indicating operation information represented by a second visualized representation in a second two-dimensional plane that is different from the first two-dimensional plane of the three-dimensional space, a display control unit that sets, such that a position of a first object of the first object group and a position of a second object of the second object group which indicate same operation information match on a common axis of the first two-dimensional plane and the second two-dimensional plane, a coordinate of the first object and a coordinate of the second object on the common axis, and a visualization unit that draws an object corresponding to an instructed visualized representation in accordance with the coordinates to perform screen display.

In addition, a display control method according to the present disclosure is a display control method performed by a display control apparatus, the display control method including reading an operation log related to operation information and generating a first object group indicating operation information represented by a first visualized representation in a first two-dimensional plane of a three-dimensional space and a second object group indicating operation information represented by a second visualized representation in a second two-dimensional plane that is different from the first two-dimensional plane of the three-dimensional space, such that a position of a first object of the first object group and a position of a second object of the second object group which indicate same operation information match on a common axis of the first two-dimensional plane and the second two-dimensional plane, setting a coordinate of the first object and a coordinate of the second object on the common axis, and drawing an object corresponding to an instructed visualized representation in accordance with the coordinates to perform screen display.

In addition, a display control program according to the present disclosure causes a computer to perform reading an operation log related to operation information and generating a first object group indicating operation information represented by a first visualized representation in a first two-dimensional plane of a three-dimensional space and a second object group indicating operation information represented by a second visualized representation in a second two-dimensional plane that is different from the first two-dimensional plane of the three-dimensional space, such that a position of a first object of the first object group and a position of a second object of the second object group which indicate same operation information match on a common axis of the first two-dimensional plane and the second two-dimensional plane, setting a coordinate of the first object and a coordinate of the second object on the common axis, and drawing an object corresponding to an instructed visualized representation in accordance with the coordinates to perform screen display.

### Effects of the Invention

According to the present disclosure, a user can easily associate elements even in a complex visualized representation with hierarchical levels when switching displays of two visualized representations.

### BRIEF DESCRIPTION OF DRAWINGS

FIG. 1 is a diagram illustrating visualized representations by a display control apparatus according to an embodiment.

FIG. 2 is a diagram illustrating an exemplary functional configuration of the display control apparatus according to the embodiment.

FIG. 3 is a flowchart illustrating a processing procedure for display control processing according to the embodiment.

FIG. 4 is a diagram illustrating exemplary display control using a visualized representation.

FIG. 5 is a diagram illustrating exemplary display control using a visualized representation.

FIG. 6 is a diagram illustrating an exemplary computer that operates a display control apparatus by executing a program.

### DESCRIPTION OF EMBODIMENTS

Hereinafter, an embodiment of the present disclosure will be described in detail with reference to the drawings. The present disclosure is not limited to this embodiment. Further, in description of the drawings, the same parts are denoted by the same reference signs.

### Embodiment

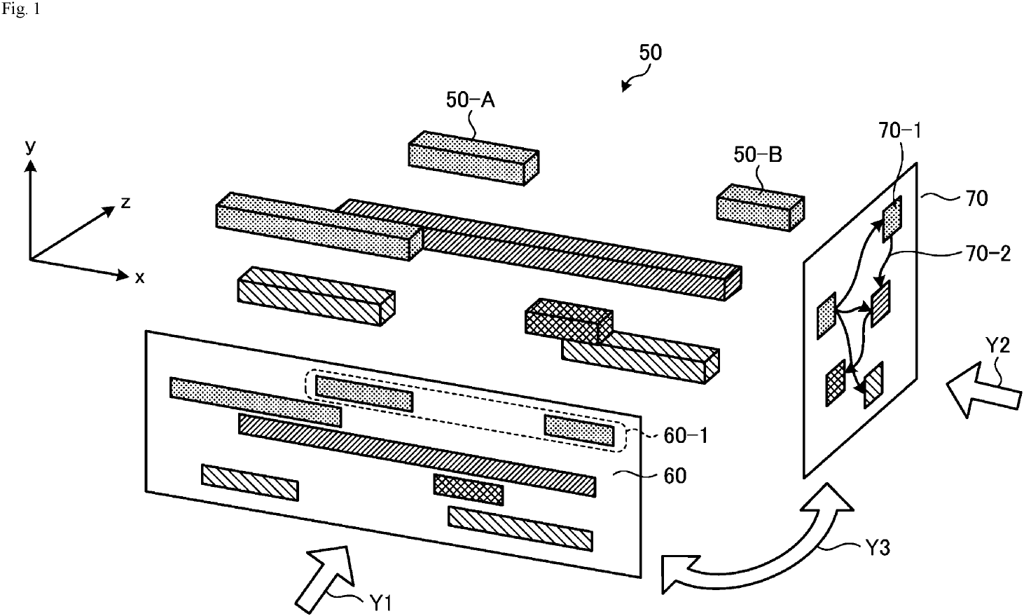

FIG. 1 is a diagram illustrating visualized representations by a display control apparatus according to an embodiment. An example of a 2.5-dimensional (2.5D) display will be described in the present embodiment, in which, in a three-dimensional (xyz) space, a three-dimensional representation 50 in which visualization object groups (for example, 50-A and 50-B) representing operation events with a hierarchical structure in rectangular parallelepipeds are disposed is viewed as a timeline display 60 (a first visualized representation) from the x-y plane (a first two-dimensional plane) side (indicated by the arrow Y1) and viewed as a node-link display 70 (a second visualized representation) from the y-z plane (a second two-dimensional plane) side (indicated by the arrow Y2) as illustrated in FIG. 1.

In the present embodiment, in a case in which the timeline display 60 and the node-link display 70 are switched (as indicated by the arrow Y3), the positions of the objects included in the timeline display 60 are set to match the positions of the objects included in the node-link display 70 before and after the switching. In other words, first in the present embodiment, in a case in which multiple visualized representations have different hierarchy settings, a hierarchical structure in which two hierarchy settings are integrated to match positions on the y axis is generated. In addition, in this embodiment, in a case in which the timeline display 60 and the node-link display 70 are rotated about the y axis that is a common axis for the x-y plane on which the timeline display 60 is displayed and the y-z plane on which the node-link display 70 is displayed to switch the display, the y-z coordinate positions of the objects are set such that the positions of the objects match in any display.

As a result, there is no change in the positions of the objects on the y axis before and after the two visualized representations are switched in the present embodiment. Thus, even if a complex visualized representation for data having a hierarchical structure is switched to another visualized representation, the user can easily associate the objects before and after the switching. Thus, in this embodiment, even complex visualized representations having a hierarchical structure can be switched seamlessly.

Further, the timeline display 60 uses, for example, a visualization method in which time is assigned to the x axis, elements (work or operations) are arranged on the y axis in a hierarchical order, and a row object 60-1 in which a temporal length of each element is formed in a rectangular shape is represented. The row object 60-1 is hierarchized by being arranged in the y axis direction in accordance with the hierarchical order, and the timeline display 60 is suitable for grasping the context and co-occurrence relationship between the elements. In the timeline display 60, for example, the group consisting of dates, users, or multiple elements (work or operations) is treated as a hierarchical level, and hierarchical levels can be set in an arbitrary order.

In addition, the node-link display 70 uses, for example, a visualization method in which an element indicating work or an operation is represented as a node 70-1 constituting a tree structure and a relationship (for example, a transition) between nodes is represented as a link 70-2, which is suitable for grasping in what order work or an operation has transitioned. In the node-link display 70, with respect to an operation log including information with multiple levels of granularity, such as an application, a window, operation content, and the like, each operation is set as a node, and the same operations are aggregated and displayed.

Further, the shape of the visualization object 50-1 illustrated in FIG. 1 is an example, and may be another shape such as a cylinder. In addition, the size of the node 70-1 and the height of the rectangle forming the row object 60-1 may be a shape that changes over time.

### Display Control Apparatus

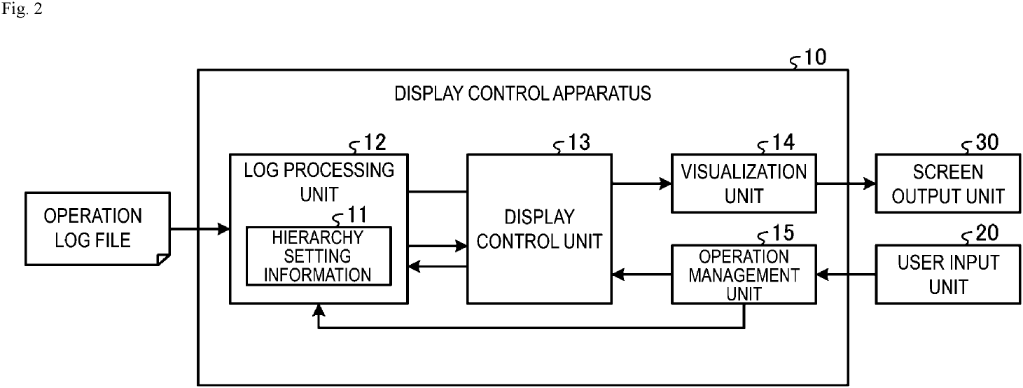

Next, a display control apparatus that achieves seamless switching of the visualized representations will be described. FIG. 2 is a diagram illustrating an exemplary functional configuration of the display control apparatus according to an embodiment. The display control apparatus 10 according to the present embodiment is connected to a user input unit 20 that receives operations of a user performing analysis, and a screen output unit 30 that outputs screens, as illustrated in FIG. 2. The display control apparatus 10 receives an input of an operation log file.

The operation log file contains information in units of multiple operations. An operation log includes, for example, terminal information, log-in user information, application information, window information, operation content, and information indicating an occurrence time. The window information includes, for example, a window title, a URL/file path, and a window handle. The operation content includes, for example, an operation target, an operation type, a value, and a captured image, and is recorded when an operation on an object in a window occurs. Further, each record of an operation log corresponds to such an operation event described above.

The display control apparatus 10 is implemented in a way that, for example, a predetermined program is read into a computer including a read only memory (ROM), a random access memory (RAM), and a central processing unit (CPU), and the CPU executes the predetermined program. In addition, the display control apparatus 10 has a communication interface through which various types of information are transmitted to and/or received from another apparatus connected via a network or the like. For example, the display control apparatus 10 includes, for example, a network interface card (NIC) to communicate with another apparatus via a telecommunication line such as a local area network (LAN) or the Internet. The display control apparatus 10 includes a log processing unit (a generation unit) 12, a display control unit 13, a visualization unit 14, and an operation management unit 15 (a management unit).

The log processing unit 12 reads an operation log related to operation information and generates an object group indicating the operation information represented by a predetermined visualized representation corresponding to each of two-dimensional planes in a predetermined two-dimensional plane of a three-dimensional space in accordance with the corresponding respective two-dimensional planes. For example, when multiple visualized representations have different hierarchy settings based on hierarchy setting information 11 which will be described below, the log processing unit 12 first generates a hierarchical structure in which two hierarchy settings are integrated. Next, the log processing unit 12 reads the operation log and generates a first object group indicating the operation information represented by a timeline display in the x-y plane of the three-dimensional space. In addition, for example, the log processing unit 12 reads the operation log and generates a second object group indicating the operation information represented by a node-link display in the y-z plane of the three-dimensional space. The first object group includes event objects that are objects each obtained by hierarchizing the operation log in a predetermined hierarchical order. The first object group includes operation events corresponding to rectangles forming a timeline. The second object group includes graphical objects that are objects each including a node group of each hierarchical level and a link group indicating a connection relationship of the nodes. The second object group includes node groups and link groups indicating relationships between nodes. The log processing unit 12, the graphical object, generates a graphical object describing a connection relationship based on the elements of each hierarchical level listed in an event object.

The hierarchy setting information 11 is information for indicating a hierarchical structure of a display target in a timeline display and a node-link display. The hierarchy setting information 11 includes a hierarchy setting Hₜ for the timeline display and a hierarchy setting Hₙₗ for the node-link display. The hierarchy setting Hₜ includes hierarchy information Nₜ indicating the order of the hierarchy in the timeline display. Here, the hierarchy information includes, for example, the order of the hierarchy, names of items constituting the hierarchy, and a collective expanded state of each hierarchical level. The hierarchy setting Hₙₗ includes hierarchy information Nₙₗ in the node-link display and key information K that is a key in aggregating and displaying nodes.

The hierarchy information Nₜ indicating the order of the hierarchy in the timeline display can set a hierarchy based on any of the user, the date, the group, the application, the window title, and the operation target. The hierarchy information Nₙₗ in the node-link display can set a hierarchy based on any of the application, the window title, and the operation target. As key information K, any of the user, the date, and the group can be set as a key.

An event object is an object in which an operation log is hierarchized in a predetermined hierarchical order. An event object is, for example, an object including a hierarchical name (for example, application, window title, operation content, etc.), a value of the element, an expanded state of the element, and an element group (subtree) of a lower hierarchical level included in the corresponding element for each element (operation information) included in each hierarchical level. Further, an expanded state of an element is set based on a collective expanded state included in the hierarchy setting information in the initial display. The lowest hierarchical level (for example, operation content) in the event object includes an operation event group as a subtree. That is, the lowest hierarchical level in the event object has an event group enumerated for the same operation content. A graphical object is an object including a node or a node group of each hierarchical level and a link or a link group indicating a connection relationship of nodes.

The display control unit 13 generates a visualization object by the number of operation events included in the event object generated by the log processing unit 12. Then, the display control unit 13 identifies a visualization object group that is treated as the same row in the timeline display based on the expanded state of the event object. Subsequently, the display control unit 13 sets display coordinates in the x-y plane and display coordinates in the y-z plane of the identified visualization object group. At this time, the display control unit 13 sets y-coordinate and z-coordinate of the visualization object so that positions of the row object and node indicating the same operation information match each other on the y axis that is the common axis between the x-y plane and the y-z plane. Then, the display control unit 13 determines a disposition of visualization objects based on the display coordinates of the event object and the graphical object. With this determination, the visualization object group corresponds to rows of the timeline display or nodes of the node-link display. By setting the same y and z coordinates to visualization object groups, when the groups are viewed as timeline display facing the x-y plane, they seem to be multiple rectangles being present in the same row, and when the groups are viewed as node-link display facing the y-z plane, they seem as one node as the visualization object groups are superimposed on each other. By indicating the viewpoint that a user desires, the user can switch viewpoints to see a visualization object group in timeline display or node-link display with the positions of objects match each other in all the display.

The visualization unit 14 draws an object corresponding to visualized representation viewed from the viewpoint indicated in the instruction information from the user input unit 20 based on the coordinates set by the display control unit 13 to perform screen display. The visualization unit 14 determines attribute values such as hue and transparency of the object corresponding to the indicated visualized representation based on the display coordinates of each object set by the display control unit 13 and draws the object as a figure using the screen output unit 30. The visualization unit 14 also performs drawing of the object such as a label, and an axis.

The operation management unit 15 receives the user input with respect to the drawing result by the visualization unit 14 from the user input unit 20, causes the log processing unit 12 to perform re-generation of an event object group when an instruction requiring a change in the structure or expansion and contraction of the hierarchy is received, and causes the display control unit 13 to update the drawn object.

### Processing Procedure of Display Processing

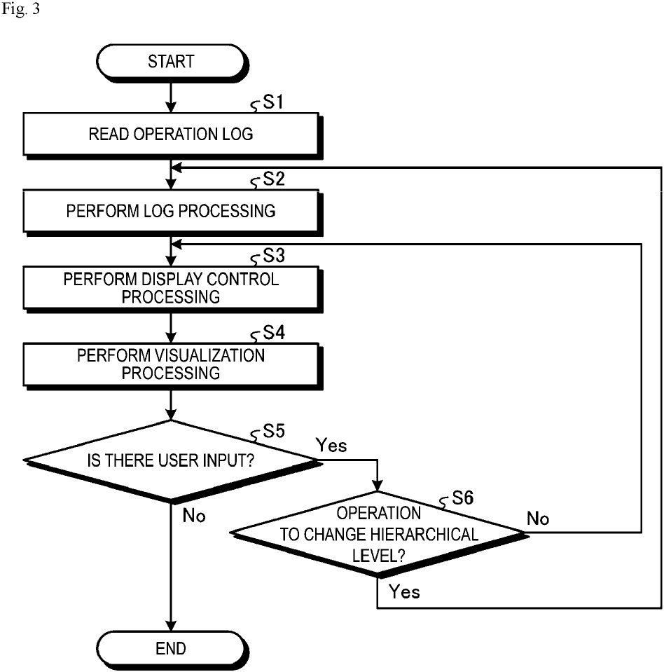

Next, a processing procedure of display control processing according to an embodiment will be described. FIG. 3 is a flowchart illustrating a processing procedure for display control processing according to the embodiment.

As illustrated in FIG. 3, the log processing unit 12 of the display control apparatus 10 reads an operation log (step S1), integrates the hierarchical structure corresponding to two visualized representations based on the hierarchy setting information 11, and performs log processing to generate event objects and graphical objects (step S2).

Next, the display control unit 13 sets the display coordinates in the x-y plane and the display coordinates in the y-z plane of the visualization objects based on the event objects and the graphical objects to perform display control processing to determine the disposition of the visualization objects (step S3). In step S3, the display control unit 13 sets y-coordinates and z-coordinates of the visualization objects so that positions of the row objects and nodes composed of the visualization object group indicated by the same operation information match each other on the y axis. The display control unit 13 determines a disposition of the visualization objects based on the display coordinates of the event objects and the graphical objects.

Then, the visualization unit 14 draws an object corresponding to the visualized representation viewed from the viewpoint indicated by the instruction information input from the user input unit 20 using the display control unit to perform visualization processing for screen display (step S4).

The operation management unit 15 determines whether the user input of the drawing result has been received from the user input unit 20 (step S5). If there is no user input (No in step S5), the operation management unit 15 ends the processing of generating a visualized representation.

If there is a user input (Yes in step S5), the operation management unit 15 determines whether the user input is an operation requiring a change in the hierarchical level of the display target (step S6).

If the user input is an operation to change the hierarchical level of the display target (Yes in step S6), the operation management unit 15 notifies the log processing unit 12 of a new hierarchy setting. In this case, the log processing unit 12 performs log processing to re-generate event objects and graphical objects (step S2). In addition, if the user input is not an operation to change the hierarchical level of the display target (No in step S6), the operation management unit 15 notifies the display control unit 13 of the object to be input. In this case, the display control unit 13 changes the expanded state of the object to be input among the event objects, and performs display control processing to update the drawn object (step S3). In step S3, the display control unit 13 performs processing of changing only the flag of the expanded state without changing the structure of the current event object that has been received from the log processing unit 12.

### Initial Disposition

Next, an initial disposition of a visualized representation displayed by the screen output unit 30 will be described. First, the log processing unit 12 arranges read operation logs in a chronological order and generates an event object with the hierarchy setting information 11.

Specifically, first, the log processing unit 12 compares a hierarchy setting Hₜ for the timeline display and a hierarchy setting Hₙₗ for the node-link display of the hierarchy setting information 11. Then, if hierarchical levels of the two hierarchy settings are different, the log processing unit 12 generates a hierarchical structure in which the two hierarchy settings are integrated, and then nests attribute names as keys in the hierarchical order included in the hierarchical structure to generate an event object E. The log processing unit 12 is, for example, Nₜ = (user, order, application, window title), and in the case of Nₙₗ = (window title, operation), the log processing unit generates a hierarchical structure of (user, order, application, window title, operation) to match the concepts of hierarchy of the two representations. In this way, if multiple visualized representations have different hierarchy settings, the log processing unit 12 generates a hierarchical structure in which the two hierarchy settings are integrated to match the display hierarchical levels of the visualized representations.

Then, if the key information K is not included in the integrated hierarchical structure, the log processing unit 12 sorts the logs using K as a key, and then generates event objects E = {e₁, ..., eₘ} (where m represents the number of elements of K) according to the hierarchical order. On the other hand, if the key information K is not included in the hierarchy information Nₜ, the log processing unit 12 generates an event object E = {e₁} according to the hierarchical order.

Then, the log processing unit 12 generates graphical objects of each eᵢ based on the event object.

Then, the display control unit 13 determines a disposition of visualization objects based on the event object and the graphical object.

First, the display control unit 13 determines an ideal disposition of node-link display on the y-z plane (the y-coordinate values and z-coordinate values of the visualization objects). Here, if there are multiple event objects, that is, if there are multiple row object groups constituting a timeline display or multiple node groups constituting a node-link display for each item set to K, that is, for each user, order, or the like, the display control unit 13 determines the identity of each object for each hierarchical level in order to draw the same row object group or node group superimposed on each other. Then, the display control unit 13 generates an object for drawing (corresponding to a row object group of a timeline or a node group) in which a group of objects that have been determined to be the same objects is integrated. A plurality of display control units 13 uses node information, link information, a mechanical model, and the like included in a hierarchy set as an initial display in accordance with the object for drawing to determine an ideal disposition (y and z coordinates) in the node-link display.

Then, the display control unit 13 matches the positions of the row object and the node indicating the same operation information on the y axis so that the node and the timeline row are easily associated when switching to the timeline display. Thus, the display control unit 13 adjusts the coordinate values of the ideal disposition given to the visualization object so that multiple elements are not displayed in a superimposing manner on the y axis when the visualized representation is switched. For example, the display control unit 13 first determines the y-coordinate of the ideal disposition that is an optimal disposition on the node-link display, and adjusts the y-coordinate of the visualization object so that the row object is not superimposed in the y axis direction in the timeline display.

Then, the display control unit 13 determines the x-coordinate value on the left end and the x-coordinate value on the right end of the object (corresponding to the left end and the right end of the rectangle of the timeline) for each visualization objects based on a timestamp.

The visualization unit 14 determines the attribute value of the visualization object based on the determined coordinate values, and draws a figure.

### User Operation

Next, a user operation for the drawing result of a visualized representation and processing of the display control apparatus 10 following the user operation will be described. Specifically, for the drawing result of the visualized representation, the user instructs a change of the hierarchical level of a display target by operating the user input unit 20. In addition, for the drawing result of the visualized representation, the user instructs expansion or contraction of the timeline with respect to rows or nodes.

Upon receiving a user input of the drawing result from the user input unit 20, the operation management unit 15, the user input, determines whether the user input is an operation requiring a change in the hierarchical level of the display target and whether the user input is an operation related to the expansion or contraction of the timeline with respect to rows or nodes. If the user input is an operation to change the hierarchical level, the operation management unit 15 notifies the log processing unit 12 of a new hierarchy setting to cause an event object to be regenerated. In addition, if the user input is an operation related to the expansion or contraction of the timeline with respect to rows or nodes, the operation management unit 15 notifies the display control unit 13 of the object to be input to update the expanded state of the drawn object.

### Display Control Example 1 of Visualized Representation

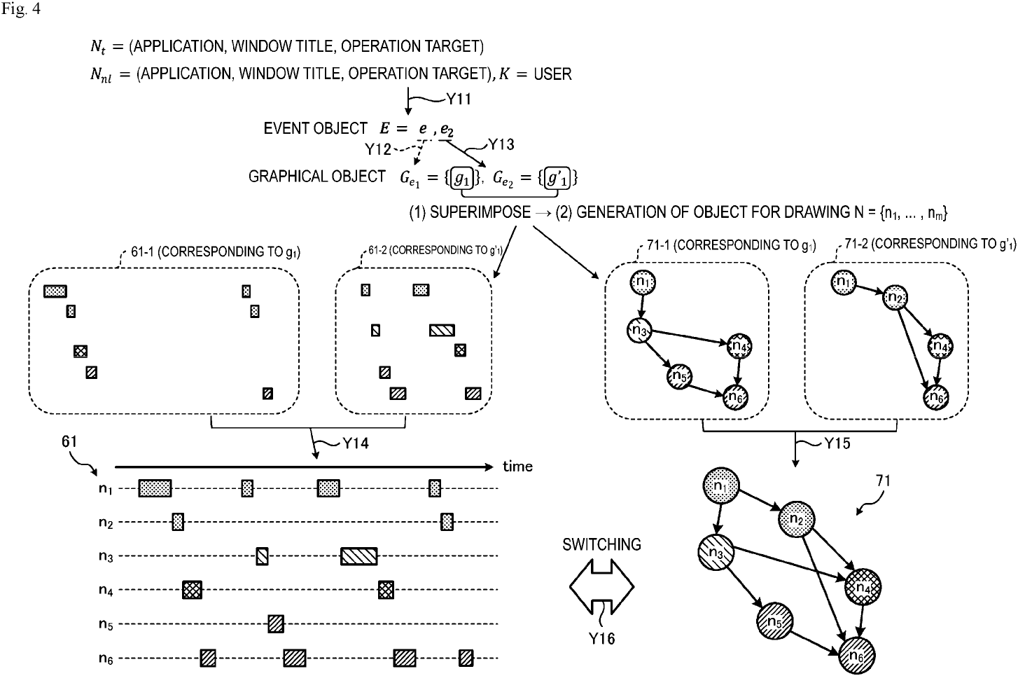

In a case in which key information K is not included in a hierarchical structure generated by integrating hierarchy information Nₜ indicating the order of the hierarchy in timeline display and hierarchy information Nₙₗ in node-link display, a visualized representation may be displayed by superimposing graphical objects thereon using K as a key. This will be specifically described with reference to FIG. 4. FIG. 4 is a diagram illustrating exemplary display control using the visualized representation.

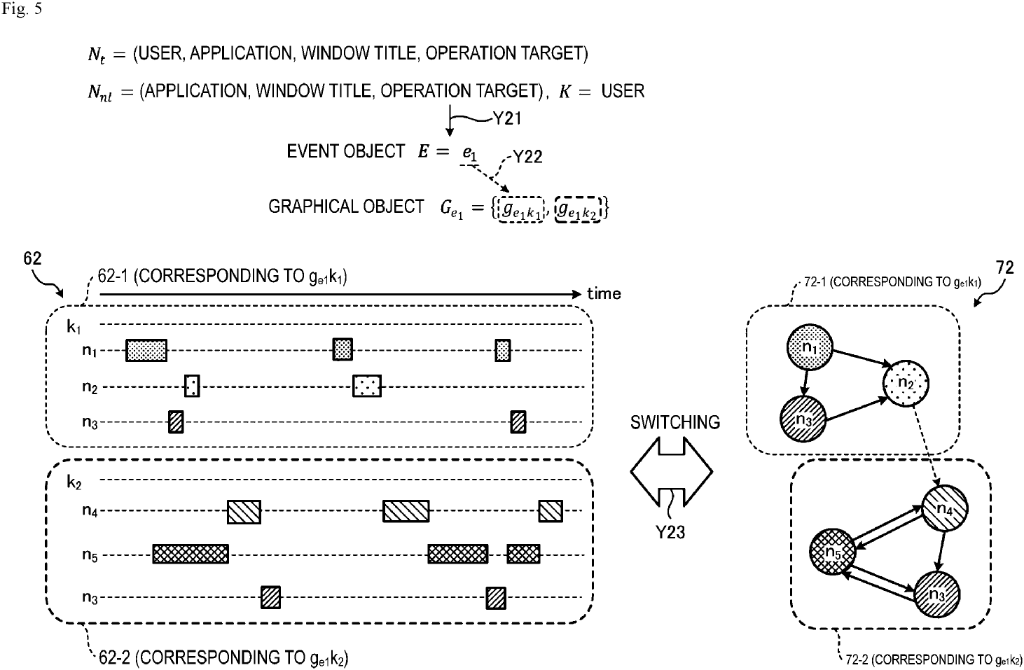

For example, a case in which hierarchy information Nₜ indicating order of a hierarchy in timeline display is equal to (application, window title, operation target) and hierarchy information Nₙₗ in node-link display is equal to (application, window title, operation target), and K is a user as illustrated in FIG. 4 will be described as an example. In other words, a case in which a superimposed key (K) is separately set from a hierarchical structure generated by integrating Nₜ and Nₙₗ will be described in FIG. 4. Further, a case where the superimposed key (K) is set in the hierarchical structure will be described in FIG. 5, which will be described below. Here, although an event object is generated by hierarchizing log data, if the key (K) is not included in the hierarchy, an event object can be generated without setting the key (K), and if a graphical object is generated by enumerating a connection relationship of each hierarchical level, there is a possibility of an unintended connection relationship appearing, and thus processing is classified by the key (K). For example, if logs of a plurality of users are mixed although a connection relationship is generated for each user, and a single event object is generated in the example of FIG. 4, a connection of an operation n₁ of a user A to an operation n₂ of a user B can be made.

Thus, because the key information K is not included in the integrated hierarchical structure (application, window title, operation target) in this case, the log processing unit 12 sorts logs using users as a key, and then generates an event object E = {e₁, e₂} (arrow Y11). In this case, e₁ corresponds to an event object of a user 1, and e₂ corresponds to an event object of a user 2.

Then, the log processing unit 12 generates graphical objects Gₑ₁{g₁} and Gₑ₂{g₂} (arrows Y12 and Y13} for each user as keys based on the event object E = {e₁, e₂}. The graphical object Gₑ₁ = {g₁} corresponds to the user 1, and the graphical object Gₑ₂ = {g₁} corresponds to the user 2.

Then, the display control unit 13 determines identity of the nodes of the graphical object Gₑ₁ = {g₁} and the graphical object Gₑ₂ = {g′₁} so that the nodes are displayed in units of applications, window titles, and operation targets, superimposes the same nodes (see (1) of FIG. 4), and thereby generates objects for drawing N = (n₁, ..., nₘ) (see (2) of FIG. 4). That is, in a case in which there are multiple graphical objects and there are the same nodes in the graphical objects, the display control unit 13 makes a setting such that the y and z coordinates of an ideal disposition of visualization objects corresponding to the nodes match.

Then, the display control unit 13 adjusts the y-coordinate of the visualization objects so that positions of the row object and node indicating the same operation information match each other on the y axis.

Through the above-described processing of the display control unit 13, a node-link display 71 is generated based on an object for drawing N (arrow Y15) obtained by superimposing a node group 71-1 included in the graphical object Gₑ₁ and a node group 71-2 included in the graphical object Gₑ₂. In addition, a timeline display 61 is generated by superimposing a row object group 61-1 included in the event object e₁ and a row object group 61-2 included in the event object e₂ (arrow Y14).

As a result, even if the visualized representation is switched to any of the timeline display 61 and the node-link display 71 (arrow Y16), display is performed such that the positions of the row objects constituting the timeline display 61 matches the position of the nodes constituting the node-link display 71 corresponding to the row objects on the y axis.

In the case in which the key information K (for example, a user) is not included in the hierarchical structure generated by integrating the hierarchy Information Nₜ indicating the order of the hierarchy in the timeline display and the hierarchy information Nₙₗ in the node-link display, when multiple operations made by different users are indicated adjacent to each other on operation logs, the display control apparatus 10 first sorts the logs using users as a key so that the operations are not regarded as the operations performed by the same user. Then, the display control apparatus 10 uses the logs sorted for each key to generate graphical objects and generate objects for drawing obtained by superimposing node groups based on the identity of the nodes, thus the same nodes are shown in a superimposed manner in node-link display, and thereby smooth analysis by the user is supported.

Furthermore, even if the visualized representation is switched to any of the timeline display and the node-link display (arrow Y16), the display control apparatus 10 performs display such that the position of the row vector of each element of the timeline display 61 matches the position of each node of the node-link display 71 on the y axis, and thus simplification of association of each object before and after the switching by the user is assisted.

### Display Control Example 2 of Visualized Representation

In a case in which key information K is included in a hierarchical structure generated by integrating hierarchy information Nₜ indicating the order of the hierarchy in timeline display and hierarchy information Nₙₗ in node-link display, the identity of a visualization object is determined based on an event object generated based on the hierarchy information. Then, the display control unit 13 sets the y and z coordinate values of the visualization object based on the determined identity.

This will be specifically described with reference to FIG. 5. FIG. 5 is a diagram for describing an example of display control using a visualized representation. For example, a case in which hierarchy information Nₜ indicating order of a hierarchy in timeline display is equal to (user, application, window title, operation target) and hierarchy information Nₙₗ in node-link display is equal to (application, window title, operation target), and K is a user as illustrated in FIG. 5 will be described as an example. In other words, a case in which a superimposed key (K) is set in a hierarchical structure generated by integrating Nₜ and Nₙₗ (user, application, window title, operation target) will be described in FIG. 5. In addition, it is assumed in FIG. 5 that a first hierarchical level (user) is expanded and displayed. That is, it is assumed that operation information in units of applications included in each user is enumerated in the timeline display and the node-link display.

Because a user is set in the hierarchical structure in which Nₜ and Nₙₗ are integrated, the log processing unit 12 generates an event object E = {e₁} that has been hierarchized based on the hierarchical structure from the operation log (arrow Y21). Then, the log processing unit 12 generates a graphical objects Gₑ₁ = {gₑ₁ₖ₁, gₑ₁ₖ₂} (arrow Y22) for each user included in the event object E = {e₁}.

Here, in terms of timeline display, row objects are disposed based on the hierarchical structure of the event object. Thus, element groups with the same application values are treated as the same row object for each user based on the expanded state of the hierarchy of the event object. That is, even in a case in which there are row objects (for example, n₃) with the same application value in a row object group 62-1 included in the subtree of a user ki and a row object group 62-2 included in the subtree of a user k₂ in the event object, the row objects are not regarded as being in the same row in the timeline display.

Thus, the display control unit 13 determines that the nodes n₃ with the same application value of the graphical objects gₑ₁ₖ₁ and gₑ₁ₖ₂ have different identities and determines the y and z coordinates of the ideal disposition for the visualization object group constituting the node group included in each graphical object. Then, the display control unit 13 adjusts the y-coordinate of the ideal disposition of the visualization objects so that positions of the row objects and nodes indicating the same operation information match each other on the y axis.

As a result, even if the visualized representation is switched to any one of the timeline display 62 and the node-link display 72 (arrow Y23), display is performed such that the positions of the row objects constituting the timeline display 62 displayed for each user match the positions of the nodes constituting the node-link display 72 on the y axis. Thus, the user can easily associate each object before and after switching.

### Effects of Embodiment

An operation log is read, and a first object group indicating operation information represented by a timeline display in an x-y plane in a three-dimensional space and a second object group indicating operation information represented by a y-z node-link display are generated in this embodiment as described above. In addition, coordinates of row objects and nodes on the y axis are set so that positions of the row objects in the first object group and the nodes in the second object group indicating the same operation information match each other on the y axis in the present embodiment. Next, in the present embodiment, an object corresponding to the indicated visualized representation is drawn based on the coordinates, and screen display is performed. Thus, when switching is performed between a timeline display and a node-link display in the present embodiment, and when switching has been performed between a timeline display and a node-link display, the positions of the objects corresponding to the same operation information on the y axis can be displayed to match each other.

Thus, because the positions of the objects on the y axis are not changed before and after the switching of the two visualized representations in the present embodiment, even if a complex visualized representation for data having a hierarchical structure has been switched to another visualized representation, a user can easily associate the objects before and after the switching. Thus, the user can achieve a more effective search while easily changing the viewpoint, and can efficiently perform work analysis.

### System Configuration of Embodiment

Each constituent component of the display control apparatus 10 illustrated in FIG. 1 is functionally conceptual and may not necessarily be physically configured as in the drawing. That is, the specific form of distribution and integration of the functions of the display control apparatus 10 is not limited to the illustration, and the entirety or a portion of the form can be configured by being functionally or physically distributed and integrated in any unit, depending on various loads, use conditions, and the like.

In addition, all or some of the processing operations performed in the display control apparatus 10 may be implemented by a CPU, a graphics processing unit (GPU), and a program that is analyzed and executed by the CPU or the GPU. In addition, the processing operations performed by the display control apparatus 10 may be implemented as hardware by a wired logic.

Further, all or some of the processing operations described as being automatically performed among the processing operations described in the embodiments may be manually performed. Alternatively, all or some of the processing operations described as being performed manually can be performed automatically using a known method. In addition, the processing procedures, control procedures, specific names, and information including various types of data and parameters described and illustrated above can be appropriately changed unless otherwise specified.

### Program

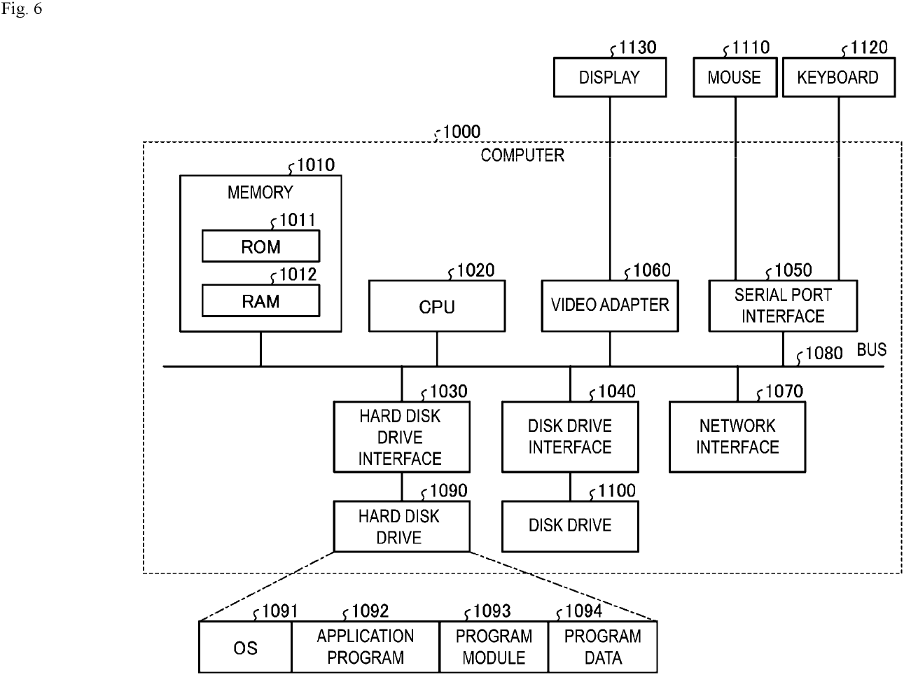

FIG. 6 is a diagram illustrating an exemplary computer that operates the display control apparatus 10 by executing a program. The computer 1000 includes, for example, a memory 1010 and a CPU 1020. Further, the computer 1000 includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, the program defining each processing operation of the display control apparatus 10 is implemented as the program module 1093 in which codes executable by the computer 1000 are described. The program module 1093 is stored in, for example, the hard disk drive 1090. For example, the program module 1093 for executing processing operations similar to the functional configurations of the display control apparatus 10 is stored in a hard disk drive 1090. The hard disk drive 1090 may be replaced with a solid state drive (SSD).

Further, configuration data to be used in the processing of the embodiment described above is stored as the program data 1094 in, for example, the memory 1010 or the hard disk drive 1090. The CPU 1020 reads the program module 1093 and the program data 1094 stored in the memory 1010 or the hard disk drive 1090 into the RAM 1012 and executes the program module 1093 and the program data 1094, as necessary.

The program module 1093 and the program data 1094 are not limited to being stored in the hard disk drive 1090 and may be stored, for example, in a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). The program module 1093 and the program data 1094 may be read by the CPU 1020 from another computer via the network interface 1070.

Although the embodiment to which the invention made by the present inventor has been applied has been described above, the present invention is not limited by the description and the drawings that form a part of the disclosure of the present invention according to the present embodiment. That is, other embodiments, examples, operational techniques, and the like made by those skilled in the art based on the present embodiment are all included in a category of the present invention.

### Reference Signs List

10 Display control apparatus
11 Hierarchy setting information
12 Log processing unit
13 Display control unit
14 Visualization unit
15 Operation management unit
20 User input unit
30 Screen output unit

1. A display control apparatus comprising:
a generation unit, implemented using one or more computing devices, configured to read an operation log related to operation information and generate a first object group indicating operation information represented by a first visualized representation in a first two-dimensional plane of a three-dimensional space and a second object group indicating operation information represented by a second visualized representation in a second two-dimensional plane, the second two-dimensional plane being different from the first two-dimensional plane of the three-dimensional space;
a display control unit, implemented using one or more computing devices, configured to set a coordinate of a first object of of the first object group and a coordinate of a second object of the second object group on a common axis of the first two-dimensional plane and the second two-dimensional plane such that positions of the first and second object indicate the same operation information; and
a visualization unit, implemented using one or more computing devices, configured to draw an object corresponding to an instructed visualized representation in accordance with the coordinates to perform screen display.

2. The display control apparatus according to claim 1,
wherein the first visualized representation and the second visualized representation have a hierarchical structure.

3. The display control apparatus according to claim 2, wherein, based on a hierarchy setting for the first visualized representation being different from a hierarchy setting for the second visualized representation, the generation unit is configured to:
generate a hierarchical structure integrated from the hierarchy setting,
generate the first object group in accordance with the integrated hierarchy setting, and
generate the second object group in accordance with the first object group.

4. The display control apparatus according to claim 1, further comprising:
a management unit implemented using one or more computing devices, configured to, based on an instruction requiring a change in a hierarchical structure or expansion and contraction of a hierarchy with respect to a drawing result obtained from the visualization unit being received, cause the generation unit to re-generate a first object group or to update an expanded state of a hierarchy and cause the display control unit to update the drawn object.

5. The display control apparatus according to claim 1, wherein a graphical structure has (i) the first object group formed from a row object forming a timeline and (ii) the second object group formed from a node and a link object indicating a relationship between a plurality of nodes.

6. The display control apparatus according to claim 5, wherein, based on a plurality of row objects or a plurality of nodes forming the timeline and a plurality of graphical structures having an identical key, the display control unit is configured to integrate the plurality of graphical structures having the identical key and determine an identity of the plurality of nodes of the plurality of graphical structures on an integrated hierarchy basis.

7. A display control method performed by a display control apparatus, the method comprising:
reading an operation log related to operation information and generating a first object group indicating operation information represented by a first visualized representation in a first two-dimensional plane of a three-dimensional space and a second object group indicating operation information represented by a second visualized representation in a second two-dimensional plane, the second two-dimensional plane being different from the first two-dimensional plane of the three-dimensional space;
setting a coordinate of a first object of of the first object group and a coordinate of a second object of the second object group on a common axis of the first two-dimensional plane and the second two-dimensional plane such that positions of the first and second object indicate the same operation information; and
drawing an object corresponding to an instructed visualized representation in accordance with the coordinates to perform screen display.

8. A non-transitory computer recording medium storing a display control program, wherein executions of the display control program causes one or more computer to perform operations comprising:
reading an operation log related to operation information and generating a first object group indicating operation information represented by a first visualized representation in a first two-dimensional plane of a three-dimensional space and a second object group indicating operation information represented by a second visualized representation in a second two-dimensional plane the second two-dimensional plane being different from the first two-dimensional plane of the three-dimensional space;
setting a coordinate of a first object of of the first object group and a coordinate of a second object of the second object group on a common axis of the first two-dimensional plane and the second two-dimensional plane such that positions of the first and second object indicate the same operation information; and
drawing an object corresponding to an instructed visualized representation in accordance with the coordinates to perform screen display.

9. The non-transitory computer recording medium according to claim 8,
wherein the first visualized representation and the second visualized representation have a hierarchical structure.

10. The non-transitory computer recording medium according to claim 9, wherein, based on a hierarchy setting for the first visualized representation being different from a hierarchy setting for the second visualized representation, generating the first object group and the second object group comprises:
generating a hierarchical structure integrated from the hierarchy setting,
generating the first object group in accordance with the integrated hierarchy setting, and
generating the second object group in accordance with the first object group.

11. The non-transitory computer recording medium according to claim 8, wherein the operations further comprise:
based on an instruction requiring a change in a hierarchical structure or expansion and contraction of a hierarchy with respect to an obtained drawing result being received, (i) regenerating a first object group or updating an expanded state of a hierarchy and (ii) updating the drawn object.

12. The non-transitory computer recording medium according to claim 8, wherein a graphical structure has (i) the first object group formed from a row object forming a timeline and (ii) the second object group formed from a node and a link object indicating a relationship between a plurality of nodes.

13. The non-transitory computer recording medium according to claim 12, wherein the operations further comprise, based on a plurality of row objects or a plurality of nodes forming the timeline and a plurality of graphical structures having an identical key, integrating the plurality of graphical structures having the identical key and determining an identity of the plurality of nodes of the plurality of graphical structures on an integrated hierarchy basis.
